(19) United States
(12) Patent Application Publication
(10) Pub. No.: US 2004/0230843 A1
(43) Pub. Date: Nov. 18, 2004

(54) System and method for authenticating users using image selection

(76) Inventor: Wayne Jansen, Bethesda, MD (US)

Correspondence Address: STITES & HARBISON PLLC, 1199 NORTH FAIRFAX STREET, SUITE 900, ALEXANDRIA, VA, 22314, US

(21) Appl. No.: 10/886,417

(22) Filed: Jul. 8, 2004

Related U.S. Application Data
(60) Provisional application No. 60/496,573, filed on Aug. 20, 2003.

(51) Int. Cl. H04L 9/32

(52) U.S. Cl. 713/202; 713/184

(57) ABSTRACT

A general-purpose method is provided for authenticating, i.e., verifying the claimed identity of, users of a computer system through the selection of a sequence of images from a displayed assembly of images. The method is based on the capability of computer systems to display and manipulate individual thumbnail images via a graphical user display interface. The method takes image sequences selected by a user and formulates a password that is dependent on both the sequence and style of their selection. To ease the users' burden of complying with organizational policy to change passwords after some period of time, the method allows the same image sequence to be used repeatedly in a password change dialogue, yet generate a completely different password value each time. A new method of “salting” passwords to make them less vulnerable is also provided.

### CROSS REFERENCE TO RELATED APPLICATIONS

This application claims benefit of U.S. Provisional Application No. 60/496,573, filed Aug. 20, 2003.

### FIELD OF THE INVENTION

The present invention relates generally to computer security and, more particularly, to methods and systems for aiding humans in securely authenticating their identity to a computing device through a visual login.

### BACKGROUND OF THE INVENTION

User authentication, as used herein, refers to the verification of an individual's claimed identity by a computer system. User authentication is the first line of defense for protecting a computer system against unauthorized use. Three basic techniques commonly used to verify identity require either some information known by an individual (i.e., knowledge-based authentication), something possessed by an individual (i.e., token-based authentication), or some measurement taken of an individual's physiological or behavioral characteristics (i.e., biometric-based authentication). Variations on these basic techniques may involve such things as location or time-of-day qualifications, and the various techniques may be used in combination.

By far the most popular authentication technique in use today, whether used as a standalone or in combination with other techniques, is the knowledge-based method involving passwords. Password mechanisms are fairly simple to implement and are suitable in situations where the user of the computer system has physical access to the system (i.e., local authentication), or network access to the system using protected communications (i.e., remote authentication). To gain access to a computer system, an individual is required to remember a sequence of alphabetic, numeric, and special characters, and then enter them, along with the claimed user identity, using a virtual or real keyboard. If the password string entered matches the password string previously bound to, i.e., uniquely assigned to or otherwise associated with, the user identity entered, the individual is successfully authenticated as that user.

Passwords are bound to a user's identity during an enrollment step. Enrolled password strings are typically stored in memory in a cryptographic form, which provides an additional level of protection over and above normal operating system access controls. The user may change his/her password after successfully completing authentication. Because enrolled passwords are not stored in clear text form, a password string entered during an authentication attempt is processed through the same cryptographic algorithm used to protect the enrolled password before the entered string is compared with the enrolled password value for verification.

The strength of the password approach lies in the large set of combinations of character strings possible. This large set makes it difficult for an intruder to identify the one needed for authenticating a user. For example, for an eight-character string populated from the set of 95 printable ASCII keyboard characters, the number of character strings possible is 95⁸ However, users tend to use easily remembered character strings to simplify authentication (“password” being one of the most common) and an intruder may easily guess the strings or systematically match the string against dictionaries of such commonly used strings.

To avoid weak or easily broken passwords, organizational policy and procedures often compel users to include special, upper case, and numerical characters in their password string, to update passwords regularly (e.g., every 60 days) with completely different strings, and to avoid common or easily guessed strings. Policy and procedures may also be backed up by technical controls that force periodic updates, and either screen passwords selected by users or supply acceptable passwords automatically for users. Unfortunately, password usage has grown over time. Not only are passwords employed to authenticate users and administrators to a computer system, but they also are used to authenticate and allow entry to different application environments, both locally and remotely, such as database, calendar, and workflow applications, and web and email servers. The number of computer systems a user may utilize daily (e.g., desktops, notebooks, Personal Digital Assistants (PDAs)) has also increased significantly. Thus, the measures put in place to ensure strong, but often meaningless passwords, frequently result in users writing them down and keeping them near the computer in order to recall them quickly, thus making it easy for an intruder to find and use them and, in essence, defeating the purpose of the password.

Considering some prior art password systems of interest, perhaps the earliest general description of a system and method for applying graphical passwords appears in U.S. Pat. No. 5,559,961 to Blonder. The authentication method described in this patent provides for the display of a set of image areas or cells that comprise a single graphical image. The user selects these predetermined areas of an image in a correct sequence, as a means of entering a password. The password is composed by allowing the user to position selected cells from the image in a location and sequence within the display interface. The selected sequence of cells is stored as a password. The cells are removed from the display when enrollment or verification is completed, leaving only the original image. One drawback appears to be that the cells, which, in effect, form the alphabet for composing a password, might offer a significantly smaller sized alphabet than that available with alphanumeric passwords. Alternatively, the cell size could be decreased in size to allow a larger alphabet, but then might have to be made so small that it would be difficult to select one cell rather than another, using a PDA touch screen.

Draw-a-Secret (DAS) is a scheme for graphical password input, targeted for PDA devices. (See Ian Jermyn, Alain May, Fabian Monrose, Michael Riter, Avi Rubin, The Design and Analysis of Graphical Passwords, Proceedings of the 8th USENIX Security Symposium, August 1999.) The user draws a design on a display grid, which is processed and used as the password. The size of each cell of the grid must be sufficiently large to allow the user a degree of tolerance when drawing a graphical password so as to avoid ambiguities. Each continuous stroke is represented as the sequence of cell grids encountered. Strokes can start anywhere and go in any direction, but must occur in the same sequence as the one enrolled for the user. Each continuous stroke is mapped to a sequence of coordinate pairs by listing the cells through which it passes, in the order in which the stroke traverses the cell boundary. The grid sequences for each stroke that compose a drawing are concatenated together in the order they were drawn to form a password. The size of the password space for graphical passwords formed using this scheme on a 5x5 grid has been shown to be, generally speaking, better than that of textual passwords.

Déjà Vu, a project at the University of California Berkeley, also involves using a set of images for user authentication. (See, Rachna Dhamija and Adrian Perrig, Déjà Vu: A User Study Using Images for Authentication, Proceedings of the 9th USENIX Security Symposium, August 2000.) Rather than using real-life images, abstract images are generated randomly using a hash visualization technique. (See also, Adrian Perrig and Dawn Song, Hash Visualization: a way to improve real world security, International Workshop on Cryptographic Techniques and E-Commerce, CrypTEC '99, 1999.) During enrollment, the user selects a set of images that make up his/her authentication base. A training phase is then used to improve the user's recognition of the abstract images within his/her authentication base. The authentication mechanism is an n-out-of-m recognition scheme, whereby the user must identify a selection of the images from the authentication base when presented to him within a much larger challenge set containing decoy images. A trusted server stores the authentication base for each user and provides the challenge set for each attempted user authentication. This makes this scheme unsuitable for handheld devices, since these devices may have only intermittent network connectivity. The server must be tightly secured to guard the confidentiality of the authentication information or else the scheme fails entirely. To counter “shoulder surfing,” learning the authentication information by looking over the shoulder of a user, different sets of images, both legitimate and decoy, may appear in random positions of the display for each authentication attempt.

A commercial product called “visual Key,” from sfr GmbH in Cologne Germany, uses cells of a single predefined image as the password elements. (Reference is made to visual Key—Technology, sfr GmbH, 2000, <URL: http://www.viskey.com/technik.html>.) The “visual Key” software forms a selection matrix by dividing a single image into cells and dynamically adjusting the grid so that cell centers align with the touch point during selection. A user must select a specific sequence of cells from the display to be granted access to the device. The strength of the password depends on the number of cells that make up the image, since this number determines the effective size of the password alphabet. Approximately 85 distinct cells with a size of 30×30 pixels can fit on a standard size 240×320 pixel, 3.5 inch display of a PDA, which results in an alphabet size smaller than the 95 printable ASCII characters available with alphanumeric passwords. One other drawback is that during selection the cells are not made visible to a user, requiring him/her to remember which part of an object in the image to select (e.g., the upper left corner of a door or window), since the object might encompass more than one cell. Moreover, cells comprised of 30×30 pixels or less are a bit small, which can contribute to selection errors.

PointSec for Pocket PC is a commercial product that includes several authentication-related components that can be managed centrally. (See Pointsec for Pocket PC, Pointsec Mobile Technologies, November 2002, <URL: http://www.pointsec.com/news/download/Pointsec PPC POP Nov 02.pdf>.)

PicturePIN is a graphical counterpart to a numeric PIN system that uses pictograms, rather than numerics, for entering the PIN via a keypad-like layout of 10 keys. The symbols, which can be tailored, are intended to form a mnemonic phrase, such as the four-symbol sequence of woman/love/flowers/daily. The sequence of symbols can be between 4 and 13 symbols long, and to increase security against “shoulder surfing,” the symbols are scrambled at each login. As an added usability feature, QuickPIN enables fast access to mobile devices within a specified number of minutes, between 30 and 300 seconds, after the last power off. QuickPIN relies on a minimum of two pictogram symbols to allow users access to their PDA. Both the PicturePIN and QuickPIN systems can be set to lock a user out from his/her data after three to an infinite number of attempts. PicturePIN supports only a limited alphabet size and a single selection style, thereby limiting its power. As an alternative, Pointsec for Pocket PC also supports traditional alphanumeric passwords.

SafeGuard PDA is another commercial product whose Symbol PIN authentication option works very similarly to PicturePIN. (See SafeGuard PDA, Utimaco Safeware AG, March 2003, <URL: http://www.utimaco.com/eng/content pdf/sq pda eng.pdf>.)

Because of these noted shortcomings, an improved system and method is needed to create password values that are both hard for an intruder to compromise and easy for the user to apply and maintain.

### SUMMARY OF THE INVENTION

In accordance with the present invention, a system and method are provided which use image selection to create strong passwords, suitable for user authentication and other security mechanisms wherein conventional passwords have been traditionally used. One important additional use is in password based encryption, wherein a password value can be transformed into a cryptographic key suitable for encrypting files or other information. Among other advantages, the method and system are particularly well suited for handheld devices and appliances having embedded processors which lack a conventional keyboard and have a restricted or small display area.

In accordance with one aspect of the invention, there is provided a method for enrolling a password to be used in verifying the claimed identity of a user of a computer system, the method comprising:

displaying a plurality of individual images using a graphical display interface; and

generating a password responsive to a selection by a user of a sequence of said displayed images based on (i) the selected sequence of the images and (ii) the manner in which the images are selected from at least two selection styles.

Preferably, the input information involved with the selection of the sequence of said displayed images used to derive the password is erased after input thereof and only a cryptographically protected form of the password is stored.

In a preferred embodiment, the mages are presented in the form of a plurality of tiles on an area of a graphical interface window. In one implementation, the tiles are presented in a regular pattern. Advantageously, the tiles are grouped in a two-dimensional matrix. In one embodiment, the matrix includes a plurality of distinct visual images. In an alternative embodiment, at least a plurality of the tiles of the matrix together form, as a mosaic, a composite visual image covering at least a portion of the plurality of tiles.

Preferably, the selection styles comprise (i) individual selection wherein a single thumbnail image represents one element of an alphabet and (ii) paired selection wherein two thumbnail images are selected and linked together to form one element of an alphabet.

Preferably, the selected sequence of images is converted into elements of an alphabet concatenated to form a clear text value of the password. Advantageously, a cryptographic hash is applied one or more times to the clear text value of password to form a cryptographically protected value of the password.

Preferably, the cryptographically protected value of the password is registered, during a password enrollment, for subsequent password verification attempts. Advantageously, the clear text value of the password is prepended or embedded with one or more random values (i.e., “salted”) prior to applying said cryptographic hash.

Preferably, the images form an image matrix and the individual images of said image matrix are mapped, one-to-one, onto the corresponding cells of a value matrix of the same dimensions as the image matrix. Preferably, the value matrix is based on randomly assigned values selected from a set of binary values that are used to form an element of an alphabet. Advantageously, the particular assignment of random values to the value matrix is retained and remains constant from one authentication attempt to another. Advantageously, the elements of the value matrix are automatically updated during a password changeover and are randomly reassigned values from said set of binary values, such that the same image sequence, if reused, results in a different password. Preferably, said value matrix, including associated salt values used in computing the password, is retained along with (i) the cryptographically protected value of the password and (ii) the identifier of the image matrix from which individual images were selected.

In one important implementation, the value matrix is used to hold individual random embedded “salt” values for forming each element of an alphabet wherein the elements of the alphabet are associated with said individual images.

Preferably, selections of visual images are made based on a theme, which identifies a set of images to display, and a chosen sequence.

In a preferred implementation, after enrollment of a user and at the option of the user, said individual images are automatically shuffled between authentication attempts.

Preferably, the images are selected graphically using a pointing device.

According to a further aspect of the invention, there is provided a method for verifying the claimed identity of a user of a computer system, said method comprising:

comparing (i) a sequence of individual visual images selected by a user as a visual password with (ii) a password previously enrolled based on a selected sequence of said visual images and stored in the computer system in a cryptographically protected form; and

permitting access to the computer system when there is a match between the selected password and the previously enrolled password.

In accordance with yet another aspect of the invention, there is provided a method for enrolling a password to be used in verifying the claimed identity of a user of a computer system, the method comprising:

displaying a plurality of individual images using a graphical display interface; and

generating a password responsive to a selection by a user of a sequence of said displayed images, the individual images being presented in an image matrix and the individual images selected being mapped onto a value matrix populated with randomly assigned values selected from a set of binary values.

Further features and advantages of the present invention will be set forth in, or apparent from, the detailed description of preferred embodiments thereof which follows.

### BRIEF DESCRIPTION OF THE DRAWINGS

FIG. 1 shows a visual display interface including a plurality of different selectable thumbnail images, in accordance with one embodiment of the invention;

FIG. 2 shows a visual display interface wherein a composite image is presented by individual tiles and squares, in accordance with a further embodiment of the invention;

FIG. 3 is a representation, shown in a perspective view, illustrating mapping from an image matrix onto a value matrix; and

FIG. 4 is a block diagram or flowchart used in explanation of the implementation of one preferred embodiment of the invention.

### DESCRIPTION OF THE PREFERRED EMBODIMENTS

As indicated above, the method and system in accordance with one aspect of the invention authenticate a user to a computer system using a visual login technique or method referred to herein as “Picture Password.” As with textual passwords, elements of an alphabet are used to form a password of a given length. However, instead of the user having to remember a string of random-like alphanumeric characters to input, a sequence of images must instead be recalled and selected. This approach is an improvement over textual passwords in that experimental results suggest that human visual memory is well suited to such visual and cognitive tasks. Further, an image sequence can be used which has some meaning to, or is otherwise of interest to, the individual user (e.g., images of baseball team logos in order of preference or of vacation spots in order visited). Moreover, if the image sequence is forgotten, the sequence may be reconstructed from the inherent visual cues.

In accordance with a preferred embodiment, the authentication method has two key distinct parts, viz., password enrollment and password verification. During password enrollment, a user chooses a theme for the thumbnail verification. During password enrollment the authentication mechanism uses the image sequence selected by the user to derive an associated password value that is registered for the user. The input information used to derive the password value is erased and only the cryptographically protected form of the password remains stored in the device. During password verification, a user again selects a sequence of thumbnail images as a visual password. The authentication system derives an associated password value and successfully authenticates the user if the newly derived password value matches the one that has been registered for the user. Users may change their registered passwords at any time, selecting a new theme and/or image sequence, provided that they have been successfully authenticated through password verification. As with other methods or systems, if a predetermined number of consecutive authentication failures occur, the user account is locked for a period of time to prevent unrestricted password guessing.

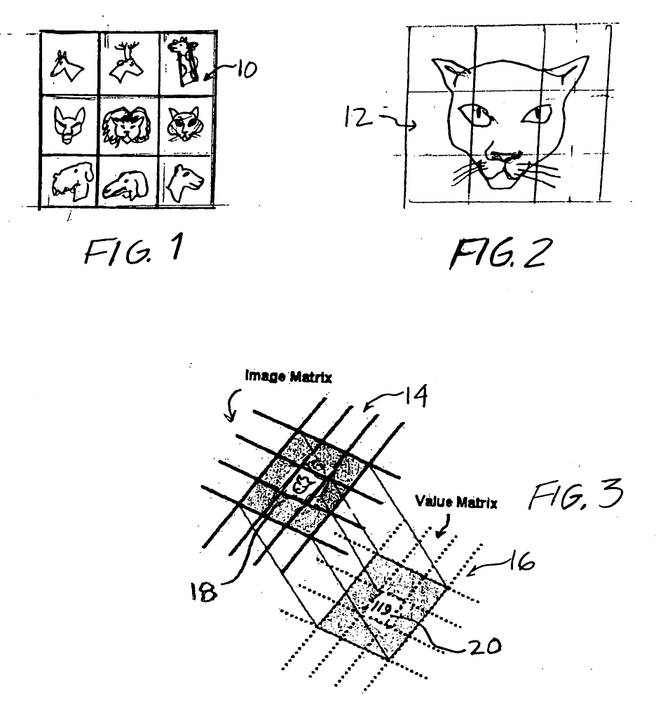

The presentation of visual images to the user for selection is based on tiling an area of the user's graphical interface window with thumbnail photo or graphic images. Various ways exist to tile an area with both regular and irregular patterns. The simplest of these is to provide squares of identical size grouped into a two-dimensional matrix. In this approach, the surface of each square displays a bit-mapped representation of some thumbnail image supplied in a predefined digital format. While thumbnail images can be distinct and individually recognizable images, they also may be used collectively in a mosaic fashion to form a larger composite image. FIGS. 1 and 2 illustrate the two different ways to prepare and display images. FIG. 1 shows a non-composite image arrangement on a 3×3 square matrix 10 with an animal theme, i.e., with a different image for each square, while FIG. 2 shows a composite image on a similar 3×3 matrix 12 wherein a single image occupies a part of all of the squares. In these embodiments, each thumbnail image appears on a set of individual squares arranged for display as a two-dimensional matrix, referred to as the image matrix. It will be appreciated that this implementation is exemplary only and that different styles of presentation, including regular and irregular shapes of images can be used as well as regimented or ad hoc arrangements within the display area.

The visual display interface presents each thumbnail image in an easy-to-select size. Users can choose from among several themes offered, such as the animal theme illustrated in FIGS. 1 and 2, to suit their personality and interests. Technically oriented users may also substitute their own set of images for display as a theme, during the initial enrollment or any subsequent enrollment. As a defense against someone watching over the user's shoulder while he/she inputs the password, users can select the option of having images shuffled automatically between authentication attempts. Though this option is better suited for themes designed for an individual display mode, it may also be used for themes designed for a mosaic display mode.

Image selection and other user interaction is preferably done graphically, using any type of pointing device available, including a mouse, touch pad, light pen, trackball, joystick, stylus or the like. The authentication mechanism completely hides its inner workings, such as password composition and verification, from the user.

In accordance with a further aspect of the invention, two styles of thumbnail image selection are provided, viz., individual selection and paired selection. Individual selection requires choosing a single thumbnail, which represents one element of the alphabet, using, for example, a tap with a stylus or a single mouse click. Paired selection requires choosing and linking a pair of thumbnail images by, for example, dragging and dropping the first thumbnail onto the second. Two thumbnail images coupled by a paired selection also represent one single element of the alphabet. This approach is similar to using a shift key to select uppercase or special characters on a traditional keyboard. In the context of this aspect of the invention, however, each thumbnail image can serve as a shift key for every other image. Additional selection styles can also be provided, if needed, by linking more than two thumbnail images together to form an individual alphabet element. Providing two or more styles of selection is an important feature of the invention for many applications in that besides significantly increasing the effective size of the alphabet, as is described in more detail below, this approach also provides additional protection against someone watching the user's hand motion, while he/she inputs the password, and using those observations to help guess the password.

With two styles of selection, the total number of alphabet elements that a user can select when enrolling a password is determined by the number of singly selectable thumbnail images, n, plus the number of possible paired thumbnail images selectable, n*(n−1), assuming for the moment that a thumbnail image is not paired with itself. For example, the total number of selectable elements for an image matrix of 16 thumbnail images is 16+(16*15) or 256, which compares favorably to the 95 printable ASCII characters, out of 128 possible, available from a conventional keyboard. Thus, a virtual keypad with only 16 keys could not only replace a conventional keyboard arrangement and conserve space, but also would double the size of the alphabet available. This is particularly advantageous as compared with conventional keyboard emulation by a handheld device, such as a PDA, where a small-size touch screen and stylus are often prove cumbersome to use when entering ASCII characters.

Turning to password derivation, it is relatively straightforward to use the indices of the image matrix to represent the elements of an alphabet. The alphabet, in turn, can be used to compute an associated password value corresponding to the images selected, in much the same way as is done for textual passwords. For example, for a 4×4 matrix whose indices range from [0,0] to [3,3], the alphabet elements would be represented by a set of 256 8-bit binary values mapped from the indices of the 16 singly selected images and the 240 paired selections. The following non-limiting example is representative of one simple mapping between indices and values of alphabet elements that could be used:

For singly selected images, their respective decimal indices are represented as a single 4-bit binary value (two bits for each index value), which is repeated to derive an 8-bit binary value as follows: [0,0]-00000000₂, [0,1]-00010001₂, [0,2]-00100010₂, [0,3]-00110011₂, [1,0]-01000100₂, [1,1]-01010101₂, [1,2]-01100110₂, [1,3]-01110111₂, [2,0]-10001000₂, [2,1]-10011001₂, [2,2]-10101010₂, [2,3]-10111011₂, [3,0]-11001100₂, [3,1]-11011101₂, [3,2]-11101110₂, [3,3]-11111111₂);

For paired image selections, assuming images are not paired with themselves, the respective decimal indices of each image are represented as a single 4-bit binary value as was shown above, and are then concatenated together to derive an 8-bit binary value as follows: [0,0][0,1]-00000001₂, [0,0][0,2]-00000010₂, [0,0][0,3]-00000011₂, [0,1][0,0]-00010000₂, [0,1][0,2]-00010010₂, [0,1][0,3]-00010011₂, [0,2][0,0]-00100000₂ . . . [3,3][3,0]-11111100₂, [3,3][3,1]-11111101₂, [3,3][3,2]-11111110₂.

Next, the values of alphabet elements corresponding to a sequence of images selected are concatenated together to form the clear text value of the password. For example, the image sequence of [0,0], [3,3], [0,0][3,3] would result in the three-element 24-bit password value of 00000000|11111111|00001111, where “|” represents the concatenation operator. A one-way cryptographic hash is then applied iteratively to the clear text password to form the cipher text value of the password. The resultant cryptographically protected value of the password is that which is registered during password enrollment and matched against during subsequent password verification attempts.

While the method and system of this aspect of the invention, by its very nature, avoids dictionary attacks associated with textual passwords, it may be possible for an intruder to compile commonly used set of image selections (e.g. location-based sequences such as the four corners or main diagonal of the image matrix) and use them in an attack. As a countermeasure to an intruder applying a dictionary of commonly used passwords, the clear text password value may be prepended with a random value, referred to as a salt, before the hash is iteratively applied. This step significantly increases the work factor for the intruder, in proportion to the size of the salt value that is used and whether or not both a public and a secret salt are used. For a discussion of salting, reference is made to Udi Manber, A Simple Scheme to Make Passwords Based on One-Way Functions Much Harder to Crack, Computers & Security, 15(2), pp. 171-176, 1996.

One further problem that the method and system of the invention addresses is password reuse. As indicated above, organizational policies typically require user's passwords to be changed completely after some period of use. This practice keeps an intruder who somehow obtains the cipher text value of the password from cracking the password over the indefinite lifetime of its use. Though the safeguard is effective, it is also a nuisance for the user, who must follow this practice on numerous systems and accounts. Ideally, the user would prefer to continue using the same image sequence indefinitely. This practice is not unreasonable in some situations such as with handheld devices, where the viewing angle of the screen is narrow and inputted information is easily shielded from view. The solution for reusing an image sequence in a secure fashion is to somehow allow the same image sequence to be used during a password changeover, but still generate a completely new password value. The method and system of the present invention enables this to be accomplished.

To allow password reuse, using the indices of an image sequence no longer is sufficient, because the resulting password, minus the prepended salt, would be the same if the same image sequence were reenrolled. Instead, a value matrix having the same dimensions of the image matrix is used as a transformation layer to allow the desired variability. In the example under consideration, each thumbnail image of the image matrix is mapped to the corresponding cell of the value matrix that contains a randomly assigned value drawn from the set of 8-bit binary values assigned to singly selected images. Recall that for the example 4×4 matrix under consideration, those values are 00000000₂, 00010001₂, 00100010₂, 00110011₂, 01000100₂, 01010101₂, 01100110₂, 01110111₂, 10001000₂, 10011001₂, 10101010₂, 10111011₂, 11001100₂, 11011101₂, 11101110₂, and 11111111₂. The value matrix holds the alphabet values to be applied when the corresponding image is selected. This is illustrated in FIG. 3, wherein the image matrix is denoted 14, the value matrix is denoted 16 and wherein, in the illustrated example, “119” is the decimal value of 01110111₂, i.e., the value of the central square. Thus, instead of using the indices of an image sequence to derive the clear text password, the elements of the value matrix are used. The mapped value of a single image selection can be directly applied, while the two mapped values of a paired image selection must first be composed into a single value, using the same technique described above. Once the thumbnail images for an image sequence have their alphabet values resolved, the values are concatenated together, in the sequence that the images were selected, to form the clear text password. In the specific example being considered here, prepending the salt value and iteratively applying the one-way cryptographic hash, as described above, forms the cryptographically protected value of the password.

The particular assignment of value elements to thumbnail images (i.e., the value matrix) is retained by the authentication mechanism, along with the salt value and protected password, and remains constant from one authentication attempt to another. However, the elements of the value matrix are updated automatically during password changeovers and randomly reassigned values from the value matrix. Thus, the value matrix approach, in accordance with this aspect of the invention, benefits users by allowing them to retain the same theme and image sequence over multiple password changeovers, yet produces a completely different password value each time.

One additional use for the value matrix is to hold individual salt values for each element of the alphabet, rather than prepending the resulting clear text value of the password with a collective salt value. As described below, when the dimensions of the image matrix are either not equal to each other or are a power of two, the memory allocated for each value matrix element (i.e., typically in 8-bit increments) may be more than sufficient to hold the values of the alphabet. In such situations, the unneeded bits can be seeded with random values to create a new way of salting the password through the embedding of salt values within the alphabet value entries of the value matrix. That is, instead of each resulting clear text password having the form <salt>|<alphabet element i>|<alphabet element j>| . . . |<alphabet element k>, each alphabet element would have an embedded salt value resulting in a clear text password of the form <salted alphabet element i>|<salted alphabet element j>| . . . | <salted alphabet element k>, where | represents the concatenation operator.

As with any authentication method and system, the method and system of the invention relies on the security of the operating environment, which may or may not involve a complete operating system in order to function securely. From the foregoing discussion, it should be clear that the invention as implemented above does rely on several critical pieces of authentication information being protected, including the salt value, the value matrix, and the enrolled password value. A compromise of this information could allow an intruder to determine systematically over time the user image sequence through an exhaustive search. For maximum effectiveness, strict file access control settings must be maintained to ensure the confidentiality and integrity of this information.

As indicated above, the method and system of the present invention are an improvement in the way users authenticate themselves through knowledge-based authentication mechanisms using a visual login technique. A specific non-limiting example will now be considered based on a Linux operating system distribution for handheld devices. It will, of course, be understood by those skilled in the art that this implementation is exemplary, that various modifications can be effected therein and that the basic principles of the invention may be applied to other embodiments.

Considering the operating environment, Linux is a cross-plafform operating system, used for embedded computing on a variety of hardware. It supports various types of device interfaces, communications, graphical user interfaces, file systems, and has many other features such as multi-processing that make it an ideal foundation for embedded applications. Linux distributions are supported on a number of Personal Digital Assistants (PDAs) including the Compaq iPAQ, the Sharp Zaurus, the Linux Digital Assistant (LDA), and the IBM Paron. These handheld devices are approximately the size of a pocket agenda whose functionality they subsume. The devices come equipped with a one-quarter VGA touch screen, use processors running at 200 MHz and higher, and have comparable amounts of read only flash memory (32 MB or more) and random access memory (64 MB or more).

The method and system of the present invention take advantage of the built-in touch screen and computational capabilities of such a handheld device, and require no additional hardware. In the implementation being considered here, the software is implemented in C++ for a Linux iPAQ PDA, and for the Open Palmtop Integrated Environment (Opie), an open-source implementation of the Qtopia graphical environment of TrollTech. Opie and Qtopia are both built with Qt/Embedded, a C++ toolkit for GUI and application development for embedded devices that includes its own windowing system. The invention, as implemented here, replaces “opie-login,” a traditional alphanumeric password mechanism currently distributed as part of Opie, which gains control of the device and mitigates access upon system boot up. The invention also replaces a PIN-type authentication mechanism, which is part of the Opie library and used to protect the desktop when resuming operation from a suspended state. The same system events used by these Opie functions at system boot up or device power on are also used in this exemplary preferred embodiment of the invention.

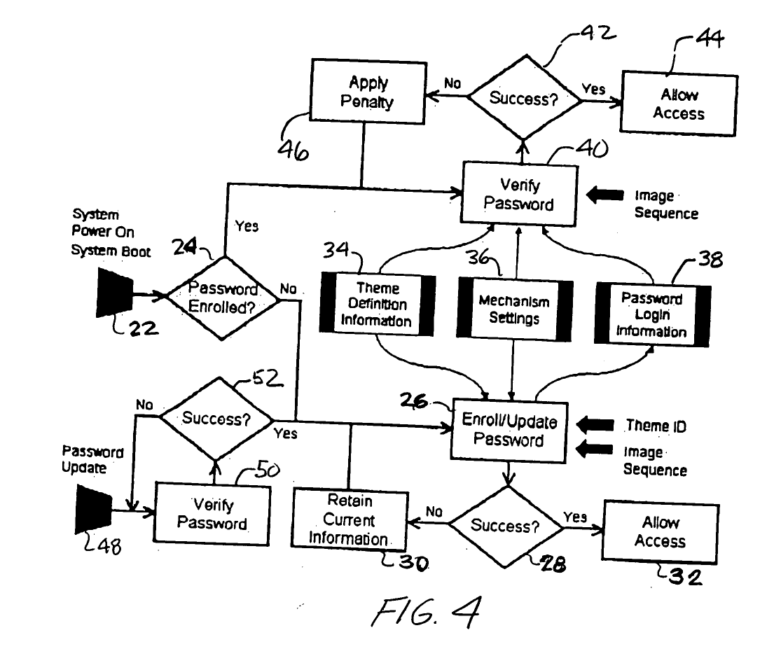

Referring to FIG. 4, a flowchart is provided which gives an overview of the basic functionality provided by this implementation of the invention within the PDA operating environment. As a personal device, there is only one user of the system who needs to be authenticated. Thus, when the system is booted up with this new software installed (block 22), the user is immediately prompted to login, as indicated by decision diamond 24, or, if not yet enrolled, to enroll an image sequence, as indicated by block 26. Unlike desktop systems, powering off a handheld device suspends all processes, rather than shutting the system down. Instead of having to initiate a time consuming boot up of the system, as with a desktop computer, powering on the device simply resumes any suspended processes. This behavior, while convenient to the user, requires that the authentication mechanism be asserted when the device is powered on (block 22), as well as during system boot up.

Enrolling the password (block 20) requires the user to select a theme and image sequence, repeating the sequence a second time to ensure that the user can accurately reenter the password. If there is a discrepancy, the user is allowed to continue to enroll his/her password until it has been accurately entered twice, as indicated by decision diamond 28 and blocks 30 and 32. A number of files containing configuration information are used for an initial enrollment. The theme definition information, block 34, identifies each theme, its name, and the images used for display in the image matrix. In principle, the system could also hold such things as the dimension of the image matrix and the size of each image to provide added flexibility to theme designers. Similarly, the mechanism settings file, block 36, contains information related to computing the password, such as the number of iterations of the hash function to use when computing the protected value of the password. When a successful enrollment occurs, the theme ID and image sequence entered by the user are saved away, along with the value matrix and salt information generated, within the password login information file, block 38, and the user gains access to the device.

Having once enrolled a password, then powering on the device after the device has been powered off, or booting up the device, the user is prompted with the enrolled theme and must enter a correct image sequence to successfully verify his/her identity, as indicated by block 40. The verification process uses the theme definition information to display the correct images for the theme recorded in the password login information file. When the image sequence is entered, verification process uses the value matrix and salt information to compute the clear text password value and applies the hash algorithm iteratively for the number of times specified in the mechanism settings file. A correct match of this result against the previously stored password value results in successful authentication of the user, and access to the device is allowed, as indicated by decision diamond 42 and block 44. A penalty is applied if the authentication is not successful as indicated by block 46.

Should a user, at any time after gaining access, choose to update his/her password (block 48), the user can launch the process using an icon installed on the palmtop for this purpose. When launched via the icon, a flag is set to indicate that password update (i.e., reenrollment) is desired. The reenrollment process first prompts the user to enter the correct image sequence for verification (block 50). The exact same steps are followed here as described above for verification at power on or boot up. It is noted that because of duplication, in FIG. 4, the information flows (viz., from blocks 34, 36, and 38) for the “Verify Process” box or block 50 associated with reenrollment are the same as those for the other identically labeled box 40 and though not shown are present implicitly. Successful password verification in this case (a “yes” output for decision diamond 52) allows the user to select a theme and image sequence for a new password value. Because a new value matrix and new salt information are generated during enrollment, choosing the same theme and image sequence results in a completely different password value. When a successful enrollment occurs, the password login file (block 38) is updated with the new information and the user regains access to the device.

Turning to the user interface, the number of thumbnail images needed to support on a target device depends on a number of factors, including the size of the display area, the viewability of images at various sizes, and the desired strength of the passwords. In general, the goal is to strike a balance among these factors so as to provide clear easily recognizable images within the display area, which are of sufficient number to enable the formation of strong passwords. In an advantageous, non-limiting embodiment, a template of 30 identically sized squares are used for the thumbnail images, with the squares being grouped into a 5×6 matrix for display. The visual interface presents images in an easy to select and view size (40×40 pixels), thereby minimizing error entries. A user can create a complex password easily during enrollment and later reenter the password quickly for validation.

Each square is implemented within the graphical interface by a display button on whose surface a bit-mapped thumbnail image appears. A singly subscripted array of 30 button elements holds the entire set of images that comprise a particular theme. The elements of the button array are displayed in sequence, from left to right, wrapped to fit within the display window that covers the entire screen. More specifically, the array of 30 button images appears as a 5×6 matrix on the display area. All thumbnails must be in a predefined digital format, currently either .bmp or .png, which can be created using an image manipulation tool such as PhotoShop or GIMP. Advantageously, several predefined themes (e.g., an “animals” theme) are provided which are selectable by the user. A message area is provided at the top of the display to guide the user actions, while the buttons at the bottom respectively allow the user to clear out any incorrect input entered or submit the entered image sequence for verification.

As indicated above, thumbnail images may also be derived from a single picture or graphic to form a composite image, where each thumbnail contributes a distinct portion of the entire picture. For example, a selected photo or portion of a photo can be divided in this way to produce a theme. With this embodiment, during enrollment, users have the flexibility to choose a particular theme from among a number of available predefined themes. It will be understood that the number of different themes is only limited by the amount of memory that the user has available to hold the different themes. Users may also configure the images so as to use their own images to replace any image within a predefined theme or to define an entirely new theme.

As mentioned previously, both single and paired selections of thumbnail images can be selected. In one advantageous implementation, single selections are made with a quick single pick of the stylus on a picture image. Paired image selection advantageously uses a touch and hold of the stylus for the first image, whereby the stylus rests on a picture image until it is highlighted, followed by a quick single pick of the second image. In these implementations, differentiating between a quick pick and a touch and hold is done by monitoring “pen down” and “pen up” events available for each button in QT embedded.

It is noted that having similar but distinct styles of selection offers some significant benefits. First, as mentioned earlier, it greatly expands the effective alphabet. Second, the subtle differences in the style of selection are difficult for someone else to monitor and later reproduce. Third, implementing paired selection as described above is more extendable than a drag-and-drop approach. This approach not only allows the same image to be paired with itself in an intuitive way, thereby increasing the alphabet size a slight bit more (i.e., by 30 elements), but this basic approach also allows images to be composed in multiples higher than two easily through cascaded operations (e.g., by touching and holding one and then another image, before a quick pick of the third image), should even larger alphabet sizes be needed for some application.

Turning to the issue of password computation and strength, similar to the image matrix, the value matrix is, in a preferred embodiment, a singly subscripted array having the same dimension. To populate a value matrix, a multi-step procedure is followed. Considering a specific non-limiting example, as a first step, each entry is assigned a random value from the full range of possible 16-bit values. The 5-bit representations for the 30 decimal values of 1-30 (i.e., 00001₂ to 11110₂) are then consecutively substituted for the least significant 5-bits of each entry, and the array sorted. Finally, the most significant 5 bits of each entry are set to zero. At this point, each element of the value matrix contains a basic alphabet value, along with a 6-bit embedded salt value and a zero prefix as shown in Table I below, which is used to compute the password. Alphabet values for singly selected images are taken directly from the corresponding element from the value matrix. Alphabet values for pair-wise selected images are formed by taking the least significant 5 bits of the value matrix entry corresponding to the second image selected and substituting these bits for the most significant 5 bits of the value matrix element corresponding to the first image of the pair.

TABLE 1

| 5 bits | 6 bits | 5 bits |
|---|---|---|
| 00000₂ | random salt value | alphabet value |
| MSB | | LSB |

With 30 thumbnail images to choose, the effective size of the alphabet is 930, (30+(30*30)). Thus, 7-entry long passwords have 930⁷ possible values or a password space of approximately 6.017008706076e+20, which is an order of magnitude greater than that for 10-character long passwords formed from the 95 printable ASCII character set at 5.987369392384e+19. The general strength relationship between passwords formed from the 5×6 picture password matrices versus textual passwords formed from the 95 printable ASCII characters is approximately

Nₚₚ=┌⅔*Nₜₚ┐,

where Nₜₚ is the required character length for textual password input, Nₚₚ is the corresponding number of alphabet elements or “passcode” length required for picture password, and ┌x┐ is the “ceiling” function, which results in the least integer greater than or equal to x. In simple terms this means that the passcode length for picture password is approximately one-third less than the length of a traditional alphanumeric password. Table II provides a comparison of element input lengths between the two mechanisms for a range of password sizes. It is noted that the values in the table presume that just as additional keystrokes are needed to select special and capital characters on a keyboard for a textual password, a comparable number of additional strokes are used when forming a passcode sequence involving paired image selections.

TABLE II

| | | | | | | | |
|---|---|---|---|---|---|---|---|
| Textual Password | 6 | 7 | 8 | 9 | 10 | 11 | 12 |
| Length | | | | | | | |
| Image Passcode | 4 | 5 | 6 | 6 | 7 | 7 | 8 |
| Length | | | | | | | |

A one-way cryptographic hash is then applied to the resulting string iteratively to form the password. In a specific non-limiting example, the NIST Secure Hash Algorithm (SHA) can be used for this purpose and will result in a 20-byte binary value. The number of iterations to apply the hash algorithm is controlled by a variable to allow the work effort to be tuned to the level of security needed. In this implementation, the user's password is never maintained in unencrypted form on the device. Only the iterative hash result is retained during enrollment and used during verification to compare against the hash result from any subsequent authentication attempt.

Considering some implementation details of the exemplary embodiment described above, modifications to the Linux kernel allowed it to take responsibility for determining when authentication should be asserted, by monitoring sleep/wake-up events and recognizing the occurrence of a system boot up. Each time the device is rebooted or powered on, the kernel initiates user authentication through a set of registered authentication handlers by starting and suspending each handler in the sequence configured for the device. Thus the kernel is able to support multiple independent authentication mechanisms, if desired, one of which can be the authentication method of the invention. Preferably, the kernel is also modified to block the input/output (I/O) ports on the device and lock down other means to bypass the authentication process until the user successfully completes authentication. The kernel patches needed to support device lockdown were developed previously as part of a general scheme to enforce corporate policies on handheld devices. (See Wayne Jansen, Tom Karygiannis, Vlad Korolev, Serban Gavrila, Michaela Iorga, Policy Expression and Enforcement for Handheld, NISTIR 6981, April 2003.) Policy controls restrict access to authentication information to the appropriate handler and also prevent the code for other protected components (i.e., the UI plug-in, user interface components, and handlers) from being deleted or replaced in an unauthorized fashion. Another kernel modification allows it to periodically check whether the authentication handlers are running, and restarts them if they should terminate due to some error.

In the exemplary embodiment under consideration, the user interface for an authentication mechanism is implemented as a set of components within a user interface (UI) plug-in module developed for Opie. As the name implies, the function of a user interface component is to interact with the user, under the control of its associated authentication handler. In this implementation of the present invention, the user interface components display the image matrix and obtain the image sequence entered by the user, which is returned in a response to the handler. Password reenrollment is also handled. The UI plug-in module, which houses all user interface components, supports a socket interface to receive commands from any of the authentication handlers that run as separate processes, and route the commands to the correct user interface component within the plug-in using a message prefix code. Similarly, the reverse response process is also supported between UI components and the module. The UI plug-in also ensures that communication occurs only with handlers that were registered with the kernel at initialization time. Communication between the UI plug-in module and the various user interface components it houses is done using the signal and slot facility provided by the Qt/Embedded windowing system. The user interface module, as a plug-in to the desktop environment, is loaded automatically by Opie upon system boot up and shares its address space.

In this embodiment, handlers perform the actual authentication and more particularly, they interact with their user interface components to tell them to bring up the specific screens, accept input, display messages, etc. Handlers also have responsibility for interactions with tokens, smart cards, the file system, etc., that are needed to perform the authentication. In the case of this implementation of the present invention, the handler has exclusive access to the mechanism settings, and password information files, which it uses to enroll a user's password and to verify authentication attempts. The user interface component has access to only the theme definition file needed to display the image matrix and accept user input. Handlers communicate with the kernel module, listening when to initiate authentication, and reporting if the authentication was successful.

A short scenario may be helpful in understanding the roles of the various components and the information flow between them for the above-described Linux implementation. The process startup and synchronization among components proceeds as follows:

On system boot-up, the kernel module loads and enforces its default policy, which blocks I/O ports on the device, hardware keys, and access to the authentication handler's code, as well as restricts access to authentication information within the file system to the appropriate authentication handler exclusively. The Linux proc file system (/proc) provides a communication channel between user space processes (UI components and handlers) and the kernel module. The kernel module registers a file in /proc file system (i.e., the /proc/mAuth file) for user space processes to trigger actions in the module.

The system startup script tells the kernel module (through the /proc/policy file) the filenames of the handler and any other related programs that need to be active. This process identifies the list of trusted handlers to the kernel. The kernel module sees that the handler programs are not running and starts them.

Upon startup, each handler program performs all necessary initialization and then reads from the /proc file entry, which causes their execution to be suspended.

Opie and its plug-ins are also loaded during boot-up. Upon loading, the UI plug-in reads up the list of registered handlers with which to communicate. Messages from other sources are ignored. At this point all the components of the system are running and the default policy of least privileges are being enforced.

The kernel module wakes up the first authentication handler, i.e., that associated with the present invention, to begin processing. Handlers check that the UI plug-in is loaded before attempting to communicate with their associated user interface components.

The handler associated with the present invention reads the authentication information from the file system and signals its user interface component via a socket interface with the identity of the theme to display and the message “Enter Passcode.”

The user interface component displays the theme, interacts with the user and accepts the image sequence, and returns that information to the handler.

The handler uses the image sequence to compute and verify the password. If the authentication attempt is successful, it reports success to the kernel module via the /proc/mAuth interface and has its user interface component remove the authentication window from the screen. If unsuccessful, the handler continues to have the user interface component prompt the user to retry until a successful authentication is completed.

When the kernel module receives an indication of success from the handler, the module suspends it, and initiates the next registered handler in its list. If this is the last handler, the kernel unlocks the device.

Although the invention has been described above in relation to preferred embodiments thereof, it will be understood by those skilled in the art that variations and modifications can be effected in these preferred embodiments without departing from the scope and spirit of the invention.

What is claimed:

1. A method for enrolling a password to be used in verifying the claimed identity of a user of a computer system, said method comprising:
displaying a plurality of individual images using a graphical display interface; and
generating a password responsive to a selection by a user of a sequence of said displayed images based on (i) the selected sequence of the images and (ii) the manner in which the images are selected from at least two selection styles.

2. A method in accordance with claim 1 wherein input information used in the selection of the sequence of said displayed images is erased after input thereof and only a cryptographically protected form of the password is stored.

3. A method in accordance with claim 1 wherein the images are presented in the form of a plurality of tiles on an area of a graphical interface window.

4. A method in accordance with claim 3 wherein the tiles are presented in a regular pattern.

5. A method in accordance with claim 4 wherein the tiles are grouped in a two-dimensional matrix.

6. A method in accordance with claim 5 wherein the matrix includes a plurality of distinct visual images.

7. A method in accordance with claim 5 wherein at least a plurality of the tiles of the matrix together form, as a mosaic, a composite visual image covering at least a portion of the plurality of tiles.

8. A method in accordance with claim 1 wherein said selection styles comprise (i) individual selection wherein a single thumbnail image represents one element of an alphabet and (ii) paired selection wherein two thumbnail images are selected and linked together to form one element of an alphabet.

9. A method in accordance with claim 1 wherein said images are converted into elements of an alphabet, concatenated to form a clear text value of the password.

10. A method in accordance with claim 9 wherein a cryptographic hash is applied one or more times to the clear text value of password to form a cryptographically protected value of the password.

11. A method in accordance with claim 10 wherein said cryptographically protected value of the password is registered, during a password enrollment, for subsequent password verification attempts.

12. A method in accordance with claim 10 wherein said clear text value of the password is prepended or systematically embedded with one or more random salt values prior to applying of said cryptographic hash.

13. A method in accordance with claim 1 wherein said images form an image matrix and the individual images of said image matrix are mapped, one-to-one, onto a value matrix of the same dimensions as the image matrix, which contains randomly assigned values selected from a set of binary values.

14. A method in accordance with claim 13 wherein the particular assignment of random values to the value matrix is retained and remains constant from one authentication attempt to another and wherein elements of the value matrix are automatically updated during a password changeover and are randomly reassigned values from said set of binary values, such that the same image sequence, if reused, results in a different password.

15. A method in accordance with claim 14 wherein the value matrix, including associated salt values used in computing the password, is retained along with (i) the cryptographically protected value of the password and (ii) the identifier of the image matrix from which individual images were selected.

16. A method in accordance with claim 13 wherein the value matrix is used to hold individual random embedded salt values for forming each element of an alphabet wherein the elements of the alphabet are associated with said individual images.

17. A method in accordance with claim 1 wherein selections of visual images are made based on a theme, which identifies a set of images to display, and a chosen sequence.

18. A method in accordance with claim 1 wherein, after enrollment of a user and at the option of the user, said individual images are automatically shuffled between authentication attempts.

19. A method in accordance with claim 1 wherein images are selected graphically using a pointing device.

20. A method for verifying the claimed identity of a user of a computer system, said method comprising:
comparing (i) a sequence of individual visual images selected by a user as a visual password with (ii) a password previously enrolled based on a selected sequence of said visual images and stored in the computer system in a cryptographically protected form; and
permitting access to the computer system when there is a match between the selected password and the previously enrolled password.

21. A method for enrolling a password to be used in verifying the claimed identity of a user of a computer system, said method comprising:
displaying a plurality of individual images using a graphical display interface; and
generating a password responsive to a selection by a user of a sequence of said displayed images, the individual images being presented in an image matrix and the individual images selected being mapped onto a value matrix populated with randomly assigned values selected from a set of binary values.
